(19) United States
(12) Patent Application Publication
(10) Pub. No.: US 2004/0222545 A1
(43) Pub. Date: Nov. 11, 2004

(54) Method for manufacturing a fabric from at least partially split yarns, fibers or filaments

(75) Inventors: Denis Reibel, Herrlisheim (FR); Delphine Guigner, Colmar (FR); Georges Riboulet, Colmar (FR); Robert Groten, Sundhoffen (FR); Ulrich Jahn, Labaroche (FR)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/730,795

(22) Filed: Dec. 9, 2003

(30) Foreign Application Priority Data
Dec. 11, 2002 (DE) 102 58 112.6-26

(51) Int. Cl. B29D 28/00; D02G 1/20

(52) U.S. Cl. 264/103

(57) ABSTRACT

A method for manufacturing a fabric from at least partially split yarns, fibers or filaments, which are formed from at least two elementary filaments and originate from a common spinneret, and are formed into one fabric, which is compressed at a temperature between the glass transition temperature (T_{g}) and the melting temperature of the polymer(s) employed to a density of at least 10% of the density of the polymer(s) used, so that, under the subsequent action of further mechanical forces, at least a partial splitting into the elementary filaments takes place.

Priority is claimed to German Patent Application No. DE 102 58 112.6-26, filed on Dec. 11, 2002, the entire disclosure of which is incorporated by reference herein.

### BACKGROUND

The present invention is directed to a method for manufacturing a fabric from at least partially split yarns, fibers or filaments.

From European patent document EP 0 814188 A, it is known to manufacture easily separable, conjugate fibers. These fibers are spun in a spinning process from two basically incompatible parent substances, such as polyethylene terephthalate and polyamide, and are separable under the action of mechanical forces, such as a water jet treatment, into their elementary filaments. From the Japanese patent documents JP A 1 00 96119, JP A 2000017519 or JP A 2001181931, conjugate fibers and textiles manufactured therefrom are known, which are produced in a spinning process from two mutually compatible polymers and are split in a splitting treatment into these elementary filaments. The German patent document DE 100 80 786 T1 and European patent document EP A 0953660 also describe textile fabrics, which are spun from mutually compatible polymers and are separated in a subsequent splitting process into fibers having a small cross section. In the process, use is made of separating agents at the phase boundaries of the polymers or of specific etching techniques.

An object of the present invention is to devise a method which will simplify the process of manufacturing fabrics from splittable fibers, yarns or filaments, increase the splitting rate, and/or the rate of at least partial splitting of conjugate fibers composed of mutually compatible polymers.

The present invention provides a method for manufacturing a fabric from at least partially split yarns, fibers or filaments, wherein, from yarns, fibers or filaments, which are formed from at least two elementary filaments, originate from a common spinneret, and are formed into one fabric, which is compressed at a temperature between the glass transition temperature (T_{g}) and the melting temperature of the polymer(s) employed to a density of at least 10% of the density of the polymer(s) used, so that, under the subsequent action of further mechanical forces, at least a partial splitting into the elementary filaments takes place. Surprisingly, it turns out that, by the action of a temperature in the mentioned range and of compression beyond the mentioned limit, conjugate yarns, fibers or filaments of mutually incompatible polymers are able to be split nearly completely into their elementary filaments, and yarns, fibers or filaments of mutually compatible polymers show evidence of at least partial splitting into their elementary filaments.

The method is advantageously carried out in such a way that the compression is undertaken at a temperature of up to a maximum of 10° C. below the melting temperature of the polymer having the lowest melting temperature. This enables a maximal splitting result to be achieved, without the yarns, fibers or filaments being melted together in the fabric.

Especially preferred is a method where the initial fabric is compressed to a density of at least 15% of the density of the polymer(s) used. At this level of compression, a splitting rate of greater than 99% is attainable when working with yarns, fibers or filaments of mutually incompatible polymers, while less energy is expended for a high-pressure water jet treatment. In comparison to a high-pressure water jet splitting and bonding known from the related art, only two treatment steps are still needed.

The initial fabric is advantageously compressed using a roll calender. This type of compression is able to be readily integrated into a continuous manufacturing process.

A hydrofluid treatment at pressures of 120-500 bar is advantageously used for the splitting operation to produce the elementary filaments. Depending on the composition of the conjugate yarns, fibers or filaments, the hydrofluid treatment at pressures of 120-500 bar achieves an at least partial, to a nearly complete splitting into the elementary filaments and to an intermingling and bonding of the fabric made thereof.

The elementary filaments of the yarns, fibers or filaments are formed quite preferably as elementary microfilaments. The splitting into elementary microfilaments results in fabrics having very small pores. In the method of the present invention, melt-spun filaments or, alternatively, staple fibers are used for this purpose.

The yarns, fibers or filaments, advantageously made up of at least two micro-elementary filaments, are advantageously composed of polymers which are compatible among themselves and are selected from the group including polyethylene/polypropylene (PE/PP), polyethylene terephthalate/polybutylene terephthalate (PET/PBT), polyethylene terephthalate/polytrimethylene terephthalate (PET/PTT), polyethylene terephthalate/recycled polyester PET/R-PES), polyethylene terephthalate/polylactate (PET/PLA), polyester/copolyester (PES/CoPES), polyamide/copolyamide (PA/CoPA), polyamide 6/polyamide 66 (PA6/PA66) and polyamide 6/polyamide 12 (PA6/PA12). Alternatively, the yarns, fibers or filaments, made up of at least two elementary microfilaments, are composed of polymers which are incompatible among themselves and are selected from the group including polyester/polyamide (PES/PA), copolyester/copolyamide (CoPES/CoPA), in particular polyethylene terephthalate/polyamide (PET/PA), and recycled polyester/polyamide (R-PES/PA). Recycled polyester is understood, in particular, to be material recovered from commercial PES bottles.

### BRIEF DESCRIPTION OF THE DRAWINGS

The present invention is explained in greater detail in the following with reference to the drawings, in which:

FIG. 1 shows a plan view of a fabric produced in accordance with Example 1;

FIG. 2 shows a plan view of a fabric produced in accordance with Example 2;

FIG. 3 shows a plan view of a fabric produced in accordance with Example 3;

FIG. 4 shows a plan view of a fabric produced in accordance with Example 4;

FIG. 5a shows a plan view of a fabric produced in accordance with comparative Example 1;

FIG. 5b shows a fabric produced in section in accordance with comparative Example 1;

FIG. 6 shows a plan view of a fabric produced in accordance with comparative Example 2; and

FIG. 7 shows a plan view of a fabric produced in accordance with Example 5.

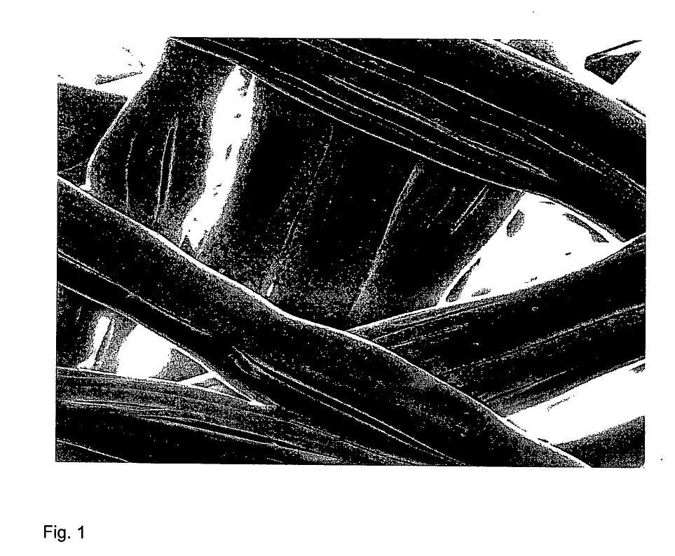

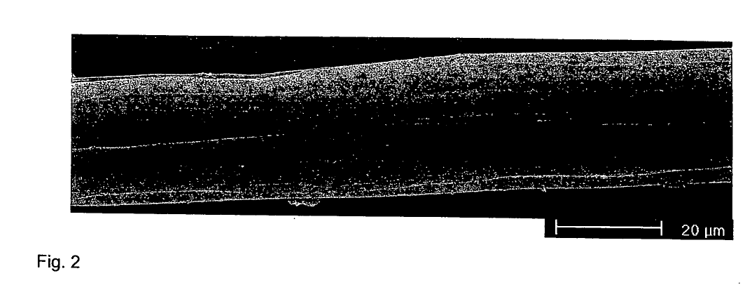

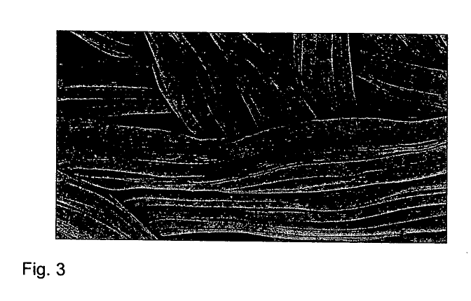

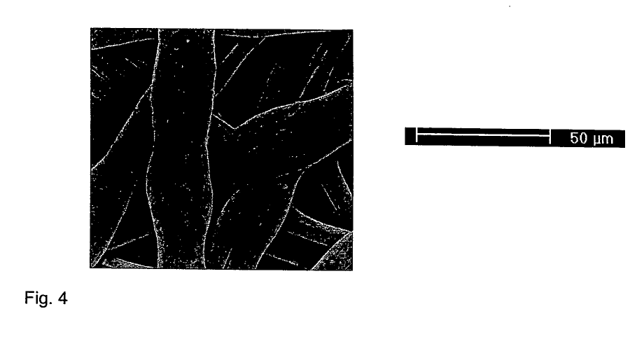

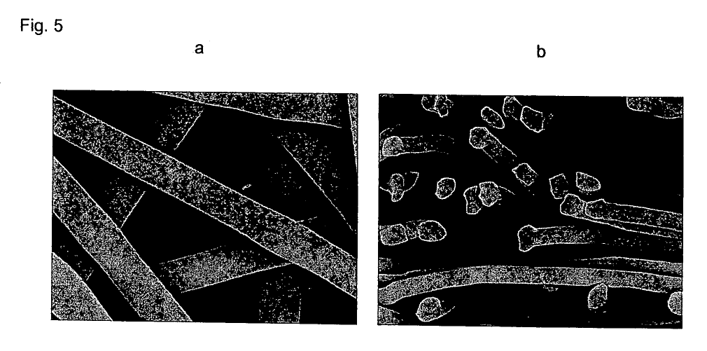

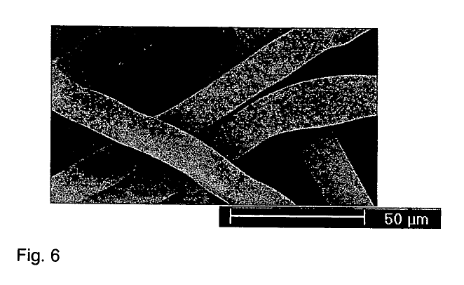

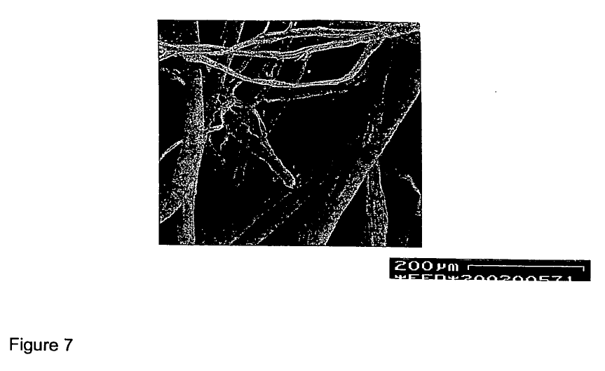

### DETAILED DESCRIPTION

### EXAMPLE 1

A fiber web is manufactured from continuous bicomponent filaments whose elementary filaments are arranged in the form of orange wedges or pie pieces transversely to the cross section. An equivalent process is described in the French patent document FR 7420254, the entire disclosure of which is incorporated herein by reference. The fiber web is composed of polyethylene terephthalate/polyamide 66 (PET/PA66) that is contained in the ratio of 70:30% by weight in the filaments. The polymers include the following additives and properties

| | Polyester | Polyamide |
|---|---|---|
| additive Ti0₂ | 0.8% | 0.4% |
| melting point | 259° C. | 256° C. |
| melting viscosity at 290° C. | 150 Pa's | 110-1150 Pa's |
| density | 1360 kg/m³ | 1130 kg/m³ |

After undergoing the drying process, the base polymers are extruded at approx. 285° C. for the PET and 280° C. for the PA66 and spun by a spinning head, which is operated at a temperature of 285° C., at a spinning rate of approximately 4,500 m/min (75 m/s), and with a throughput of about 1 g/hole/min (60 g/hole/h). The filaments are subsequently cooled, subjected to a drawing process and laid up to form a fiber web, as already described in the aforementioned document FR 7420254. The fiber web has a mass per unit area of approx. 130 g/m² and is directly fed, following the fiber web formation, to a calender by two metal rolls heated to 160° C., which have a pressing pressure of 15 daN/cm width and are operated at a speed of 10 m/min (600 m/h). The calendering operation results in a density of 570 kg/m³ (44.15% of the density of the polymers) of the fabric. The combined effect of temperature and pressure, as well as the shearing stresses during the calendering process lead to a pre-splitting of the filaments.

Following the calendering process, the fiber web is nearly completely split into the elementary microfilaments by the treatment with high-pressure water jets, and is intermingled and thereby bonded. The conditions and the means for implementing the hydraulic bonding correspond substantially to those described in the document FR 7420254. Following the splitting operation, the elementary filaments have a titer of 0.15 dTex.

### EXAMPLE 2

A continuous bicomponent filament composed of polyethylene terephthalate/polyamide 6 (PET/PA6), where the elementary filaments are alternately arranged in the form of pie pieces, viewed over the cross section, is produced in accordance with the process already mentioned in accordance with FR 7420254. Departing from Example 1, the PA 6 is extruded at 260° C. The other spinning conditions correspond to those of Example 1.

| | Polyester | Polyamide |
|---|---|---|
| additive Ti0₂ | 0.8% | 0.4% |
| melting point | 259° C. | 224° C. |
| melting viscosity at 290° C. | 150 Pa's | |
| melting viscosity at 260° C. | | 160 Pa's |
| density | 1360 kg/m³ | 1130 kg/m³ |

The calendering conditions are simulated in that a filament is pressed at a pressure of 300 bar between two plates heated to 180° C., the combined effect of temperature and pressure resulting in a pre-splitting of the filaments.

### EXAMPLE 3

A fiber web is produced from bicomponent staple fibers. The staple fibers have a V-shaped cross section of the polyethylene terephthalate, at whose ends polyamide 6 components are arranged. The fiber web obtained has a mass per unit area of 50 g/m² and, immediately following the fiber web-forming process, is pressed at a pressing pressure of 300 bar between two plates heated to 180° C. The combined effect of temperature and pressure results in a pre-splitting of the filaments.

### EXAMPLE 4

A nonwoven fabric web produced from continuous conjugate filaments, which are composed of polyethylene terephthalate/polybutylene terephthalate (PET/PBT) and are in a proportion of 70:30% by weight, is manufactured analogously to the process described in the document FR 7420254. The PET corresponds to Example 1, and the other spinning conditions are also identical to those described in Example 1. The PBT is extruded at 250° C.

| | PET | PBT |
|---|---|---|
| additive Ti0₂ | 0.8% | 0.4% |
| melting point | 259° C. | 225° C. |
| melting viscosity at 290° C. | 150 Pa's | 350 Pa's |
| density | 1360 kg/m³ | 1130 kg/m³ |

The fiber web obtained has a mass per unit area of 170 g/m² and, immediately following the fiber web-forming, is pressed at a pressure of 400 bar between two plates at a temperature of 200° C. As a result, the density of the fiber web reaches 770 kg/m³ (57.38% of the density of the polymers). The combined effect of temperature and pressure results in a pre-splitting of the filaments.

### COMPARATIVE EXAMPLE 1

A continuous fiber web having the same filament composition and arrangement is manufactured under the same spinning conditions as described in Example 4. This fiber web is heated, immediately following laying of the fiber web, in an oven to 200° C. for 30 seconds. The density of the fiber web is 110 kg/m³ (8.2% of the density of the polymers). Following this treatment, the fiber web undergoes a hydraulic bonding under the conditions and using the means substantially comparable to those in the described document FR 7420254. The fiber web, subjected to only one temperature treatment, does not show evidence of any splitting into the elementary filaments.

### COMPARATIVE EXAMPLE 2

A continuous fiber web of filaments having the same fiber composition and arrangement is manufactured under the spinning conditions described in Example 4. Immediately following laying of the fiber web, the fiber web is pressed at room temperature at a pressure of 400 bar. As a result, the density of the fiber web reaches 370 kg/M³ (28.65% of the density of the polymers). Under these conditions, there is no splitting into the elementary filaments.

### EXAMPLE 5

A fiber web is manufactured from bicomponent filaments in an orange-wedge array of the elementary filaments in accordance with the process described in the document FR 7420254. The filaments are composed of polyethylene terephthalate/polytrimethylene terephthalate (PET/PTT) having a weight proportion of 70:30%. The PTT is extruded at 250° C. The PET and the spinning conditions are identical to those described in Example 1.

| | PET | PTT |
|---|---|---|
| additive Ti0₂ | 0.8% | |
| melting point | 259° C. | 240° C. |
| melting viscosity at 290° C. | 150 Pa's | 500 Pa's |
| density | 1360 kg/m³ | 1350 kg/m³ |

The fiber web has a mass per unit area of 130 g/m² and is compressed immediately following laying of the fiber web by calendering between two heated metal rolls. One of the metal rolls is an engraved roll having 52 teeth/cm², the other a smooth-surfaced roll, which is operated at a temperature of 160° C. At a pressing pressure of 30 daN/cm width and a calendering speed of 15 m/min (900 m/h), a density of the fiber web of 760 kg/M³ (56.0% of the density of the polymers) is attained. Following the calendering operation, the fiber web is subjected to a water-jet treatment resulting in a splitting and intermingling of the elementary filaments.

What is claimed is:

1. A method for manufacturing a fabric from yarns, fibers or filaments, including first elementary filaments of a first polymer and second elementary filaments of a second polymer, the method comprising:
receiving the yarns, fibers or filaments, from a common spinneret;
forming the yarns, fibers or filaments into a single first fabric;
compressing the first fabric to a density of at least 10% of a density of the first polymer, the compressing being performed at a temperature between a glass transition temperature and a melting temperature of the first polymer; and
subsequently applying a further mechanical force so as to cause an at least partial splitting of the yarns, fibers or filaments into the first and second elementary filaments.

2. The method as recited in claim 1, wherein the applying of the further mechanical force is performed at a temperature of at least 10° C. below a melting temperature of the first polymer.

3. The method as recited in claim 2, wherein the melting temperature of the first polymer is equal to or lower than a melting temperature of the second polymer.

4. The method as recited in claim 1, wherein the compressing is performed to a density of at least 15% of the density of the first polymer.

5. The method as recited in claim 1, wherein the compressing is performed using a roll calender.

6. The method as recited in claim 1, wherein the applying of the further mechanical force includes applying a hydrofluid treatment at a pressure of 120 to 500 bar.

7. The method as recited in claim 1, wherein the first and second elementary filaments are elementary microfilaments.

8. The method as recited in claim 1, wherein the yarns, fibers or filaments include melt-spun filaments.

9. The method as recited in claim 1, wherein the yarns, fibers or filaments include staple fibers.

10. The method as recited in claim 1, wherein the first and second elementary filaments are micro-elementary filaments and the first and second polymers are compatible polymer pairs.

11. The method as recited in claim 10, wherein the first and second polymers are selected from the group consisting of: polyethylene/polypropylene; polyethylene terephthalate/polybutylene terephthalate; polyethylene terephthalate/polytrimethylene terephthalate; polyethylene terephthalate/recycled polyester; polyethylene terephthalate/polylactate; polyester/copolyester; polyamide/copolyamide; polyamide 6/polyamide 66; and polyamide 6/polyamide 12.

12. The method as recited in claim 1, wherein the first and second elementary fibers include micro-elementary filaments and the first and second polymers are incompatible polymer pairs.

13. The method as recited in claim 12, wherein the first and second polymers are selected from the group consisting of: polyester/polyamide; copolyester/copolyamide; polyethylene terephthalate/polyamide; and recycled polyester/polyamide.
